(19) United States
(12) Patent Application Publication
(10) Pub. No.: US 2016/0318330 A1
(43) Pub. Date: Nov. 3, 2016

(54) BLANKET, PRINTING DEVICE, PRINTING METHOD, AND BLANKET MANUFACTURING METHOD

(71) Applicant: Jun SAKAMOTO, Osaka (JP)

(72) Inventor: Koji SAKAMOTO, Osaka-shi (JP)

(73) Assignee: Jun SAKAMOTO, Osaka (JP)

(21) Appl. No.: 15/104,869

(22) PCT Filed: Dec. 22, 2014
(86) PCT No.: PCT/JP2014/083920

§ 371 Date: Jun. 15, 2016

(30) Foreign Application Priority Data
Dec. 20, 2013 (JP) 2013-264054

(51) Int. Cl. B41N 10/02; B41F 7/08

(52) U.S. Cl. CPC B41N 10/02; B41F 7/08

(57) ABSTRACT

A blanket (21) according to the present invention is an offset printing blanket (21) having a surface (H), wherein the surface (H) has a recess forming region (30), the recess forming region (30) includes a plurality of recess regions (32) each defining a recess and upper regions (31) each defined by adjacent recess regions (32) among the plurality of recess regions (32), the upper regions (31) have top surfaces (33a and 33b), and the recesses (35a, 35b, and 35c) have bottom surfaces (34a, 34b, and 34c) parallel to the top surfaces (33a and 33b).

### TECHNICAL FIELD

The present invention relates to a blanket, a printing device, a printing method, and a blanket manufacturing method.

### BACKGROUND ART

Offset printing is known as one of printing techniques. In offset printing, ink is transferred from a printing plate to a transfer roll, and then transferred from the transfer roll to a printing target. Such offset printing is also referred to as lithographic printing.

A printing device disclosed in Patent Literature 1 includes three printing units and prints inks on a printing target one on top of another to form a thick electrode.

### CITATION LIST

### Patent Literature

### [Patent Literature 1]

Japanese Patent Application Laid-Open Publication No. 2011-178006

### SUMMARY OF INVENTION

### Technical Problem

However, the printing device disclosed in Patent Literature 1 includes printing units that are each capable of printing only a small amount of ink, and therefore cannot form a thick layer through one single transfer.

In view of the above-mentioned problem, the present invention has been made to provide a blanket capable of printing a thick film on a printing target, a printing device, a printing method, and a blanket manufacturing method.

### Solution to Problem

A blanket according to the present invention is an offset printing blanket having a surface, wherein the surface has a recess forming region, the recess forming region includes a plurality of recess regions each defining a recess and a plurality of upper regions each defined by adjacent recess regions among the plurality of recess regions, the plurality of upper regions each have a top surface, and the plurality of recesses each have a bottom surface parallel to the top surface.

In one embodiment, the plurality of recess regions are larger than the plurality of upper regions in the recess forming region.

In one embodiment, the plurality of recesses each have a depth of 0 mm-3 mm.

In one embodiment, the plurality of recesses each have a size of 30 μm-1,000 μm.

In one embodiment, the plurality of recesses are arranged in a grid.

A printing device according to the present invention includes: a transfer roll having the above-described blanket and a core; and a printing plate, wherein the blanket transfers, to a printing target, an ink transferred from the printing plate.

In one embodiment, a thickness of the ink transferred to the plurality of recesses is greater than a thickness of the ink transferred to the top surfaces.

In one embodiment, the bottom surfaces of the plurality of recesses are parallel to an outer circumferential surface of the core.

A printing method according to the present invention includes: providing a printing device including a printing plate and an offset printing blanket having a surface; transferring an ink from the printing plate to the blanket; and transferring the ink from the blanket to a printing target, wherein the surface has a recess forming region, the recess forming region includes a plurality of recess regions each defining a recess and a plurality of upper regions each defined by adjacent recess regions among the plurality of recess regions, the plurality of upper regions each have a top surface, and the plurality of recesses each have a bottom surface parallel to the top surface.

In one embodiment, the transferring to the blanket and the transferring to the printing target are repeated a plurality of times.

In one embodiment, the printing device further includes a conveyance section configured to convey the printing target, and the transferring to the printing target includes adjusting a position of the ink to be transferred from the plurality of recesses to the printing target by adjusting a speed at the conveyance section.

A blanket manufacturing method according to the present invention includes: preparing a mold having a plurality of protrusions; and pouring a blanket material into the mold, wherein the blanket has a surface, the surface has a recess forming region, the recess forming region includes a plurality of recess regions each defining a recess and a plurality of upper regions each defined by adjacent recess regions among the plurality of recess regions, the plurality of upper regions each have a top surface, and the plurality of recesses each have a bottom surface parallel to the top surface.

### Advantageous Effects of Invention

The blanket according to the present invention includes a plurality of upper regions each having a top surface and a plurality of recesses each having a bottom surface parallel to the top surface. The ink can therefore be held also in the plurality of recesses, and thus the amount of the ink that can be printed through a single run of printing can be increased. As a result, a thick film can be printed on a printing target.

### BRIEF DESCRIPTION OF DRAWINGS

FIG. 1 is a schematic diagram of an embodiment of a printing device according to the present invention.

FIG. 2A is a schematic diagram illustrating a transfer roll of the printing device according to the embodiment of the present invention.

FIG. 2B is a schematic enlarged view of a recess forming region illustrated in FIG. 2A.

FIG. 2C is a schematic cross-sectional view taken along line IIc-IIc of FIG. 2B.

FIGS. 3A-3D are schematic diagrams illustrating a printing method performed by the printing device according to the embodiment of the present invention.

FIG. 4 is a schematic enlarged view illustrating the transfer roll according to the embodiment of the present invention.

FIG. 5 is a schematic diagram of an embodiment of the printing device according to the present invention.

FIG. 6 is a schematic side view of inks stacked in layers on a printing target.

FIG. 7A is a schematic diagram illustrating a mold that is used for manufacturing a blanket according to the embodiment of the present invention.

FIG. 7B is an enlarged view of the mold.

FIGS. 8A and 8B are schematic diagrams for illustrating a relationship between the area of upper regions and the area of recess regions in the recess forming region.

### DESCRIPTION OF EMBODIMENTS

The following describes embodiments of a blanket, a printing device, a printing method, and a blanket manufacturing method according to the present invention with reference to the drawings. However, the present invention is not limited to the following embodiments.

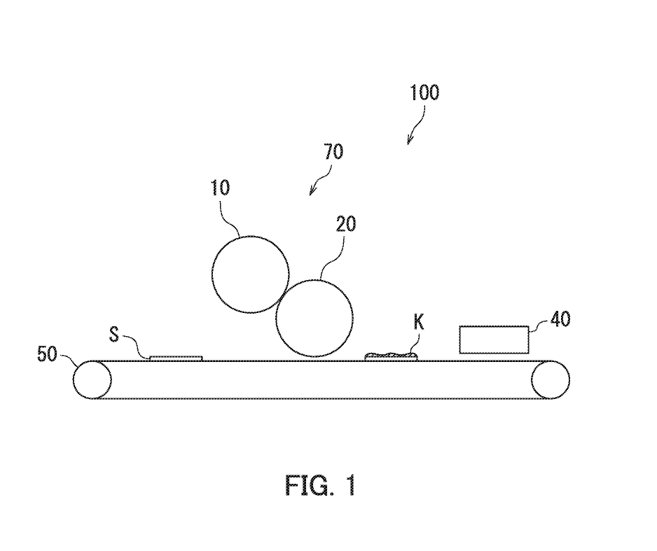

A printing device 100 according to an embodiment of the present invention is described with reference to FIG. 1. FIG. 1 is a schematic diagram of the embodiment of the printing device 100 according to the present invention. The printing device 100 according to the present embodiment includes a printer 70. The printing device 100 further includes a conveyance section 50 that conveys a printing target S. The printing device 100 may further include a heater 40. The printer 70 has a pattern roll 10 and a transfer roll 20. The pattern roll 10 and the transfer roll 20 are each rotatable. In the present embodiment, the pattern roll 10 and the transfer roll 20 have substantially the same diameter.

A surface of the pattern roll 10 is metal-plated. Typically, grooves in a specific pattern are formed in the pattern roll 10. The pattern corresponds to lines, graphics, motifs, and the like to be printed on the printing target S. A surface of the transfer roll 20 is provided with a blanket. Typically, the blanket is formed from a rubber. For example, the blanket is formed from silicone rubber.

The printing device 100 performs printing with both the pattern roll 10 and the transfer roll 20 rotating. An ink K is transferred from the rotating pattern roll 10 to the rotating transfer roll 20 and travels with the rotation of the transfer roll 20 to a lowest position on the transfer roll 20. The ink K is transferred from the transfer roll 14 to the printing target S through contact of the transfer roll 20 with the printing target S at the lowest position on the transfer roll 20. Thus, printing of the ink K is performed.

In the present embodiment, the pattern roll 10 and the transfer roll 20 have substantially the same diameter. However, the present invention is not limited to such a configuration. The pattern roll 10 and the transfer roll 20 may each have a different diameter. Preferably, the diameter of one of the pattern roll 10 and the transfer roll 20 is an integral multiple of the diameter of the other.

The ink K may contain a conductive material. For example, the ink K contains a particulate conductive material and a vehicle. The vehicle contains a resin and a solvent. Where the ink K contains a conductive material, the resistance of the conductive material is reduced as a result of a thick film transferred onto the printing target S. Furthermore, the ink K may contain a pigment. Alternatively, the ink K may contain a coating agent. In such a case, a surface of the printing target S can be treated through the printing device 100 printing the ink K thereon. Where the ink K contains a coating agent, protection on the printing target S is enhanced as a result of a thick film transferred onto the printing target S. The printing device 100 can print the ink K on the printing target S at high speed, and therefore allows mass production of surface-treated printing targets S.

The ink K is supplied to the pattern roll 10 by any method. For example, the ink K may be dropped from above the pattern roll 10, or the ink K may be supplied from an ink reservoir (not illustrated). Alternatively, the ink K may be ejected from a nozzle (not illustrated) toward the pattern roll 10. Furthermore, a scraper, not illustrated, may be attached to the pattern roll 10, and an amount of ink accumulated at or around an interface between the pattern roll 10 and the scraper may be detected by a sensor in order to control supply of the ink K to the pattern roll 10.

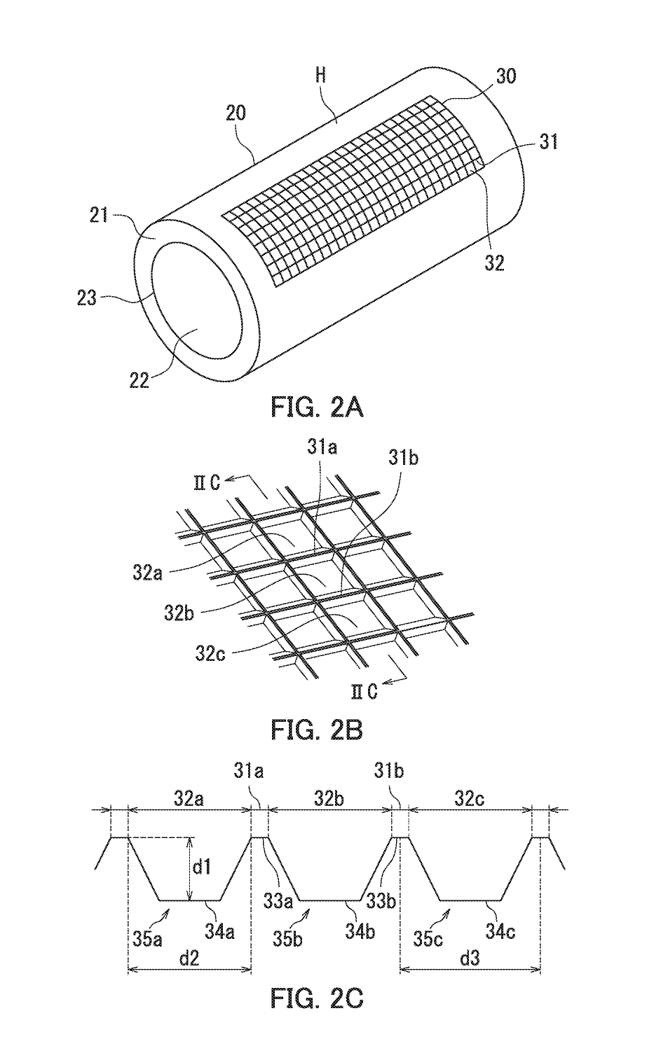

The transfer roll 20 of the printing device 100 according to the embodiment of the present invention is described with reference to FIGS. 2A-2C. FIG. 2A is a schematic diagram illustrating the transfer roll 20 of the printing device 100 according to the embodiment of the present invention. FIG. 2B is a schematic enlarged view of a recess forming region illustrated in FIG. 2A. FIG. 2C is a schematic cross-sectional view taken along line IIc-IIc of FIG. 2B.

The transfer roll 20 is described with reference to FIG. 2A. The transfer roll 20 has a blanket 21 and a core 22. The core 22 has an outer circumferential surface 23. The blanket 21 is attached to the outer circumferential surface 23 of the core 22.

A surface H of the blanket 21 has a recess forming region 30. The recess forming region 30 includes a plurality of recess regions 32 and a plurality of upper regions 31. Each of the plurality of recess regions 32 defines a recess. The plurality of recesses are arranged in a grid. The upper regions 31 connect the plurality of recess regions 32.

The recess forming region 30 is described with reference to FIGS. 2B and 2C. The recess forming region 30 includes the plurality of recess regions 32 (a recess region 32a, a recess region 32b, and a recess region 32c) and the plurality of upper regions 31 (an upper region 31a, and an upper region 31b). Each of the plurality of recess regions 32 has a recess (a recess 35a, a recess 35b, and a recess 35c). Each upper region 31 is defined by adjacent recess regions 32. The plurality of recesses (the recess 35a, the recess 35b, and the recess 35c) respectively have bottom surfaces (a bottom surface 34a, a bottom surface 34b, and a bottom surface 34c) parallel to top surfaces (a top surface 33a and a top surface 33b).

The plurality of recess regions 32 are larger than the upper regions 31 in the recess forming region 30. The plurality of recess regions 32 for example account for 50%-95% of the recess forming region 30. In the blanket 21 attached to the core 22, the bottom surfaces are disposed along the surface of the core. In the blanket 21 attached to the core 22, the top surfaces are disposed along the surface of the core.

The plurality of recesses 35 for example each have a depth d1 of greater than 0 mm and no greater than 3 mm. Preferably, the depth d1 is at least 0.3 mm and no greater than 0.4 mm. The plurality of recesses 35 for example each have a size d2 of at least 30 μm and no greater than 1,000 μm. A pitch d3 of the plurality of recesses is for example at least 30 μm and no greater than 1,000 μm.

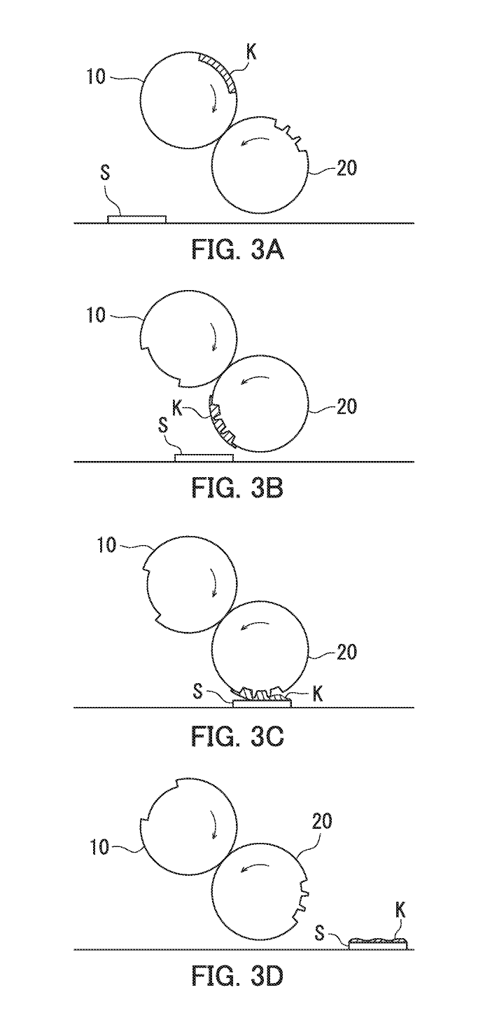

A printing method performed by the printing device 100 according to the embodiment of the present invention is described with reference to FIGS. 3A-3D. FIGS. 3A-3D are schematic diagrams illustrating the printing method performed by the printing device 100 according to the embodiment of the present invention.

As illustrated in FIG. 3A, the ink K is supplied to the grooves formed in the pattern roll 10. Note that both the transfer roll 20 and the pattern roll 10 are rotating at the same speed.

As illustrated in FIG. 3B, the pattern roll 10 transfers the ink K to the transfer roll 20. The ink K is transferred to the transfer roll 20 when the ink K on the rotating pattern roll 10 comes in contact with the transfer roll 20.

As illustrated in FIG. 3C, the transfer roll 20 transfers the ink K to the printing target S. The ink K is transferred to the printing target S when the ink K on the rotating transfer roll 20 comes in contact with the printing target S.

As illustrated in FIG. 3D, the ink K transferred to the printing target S has high fluidity, and therefore spreads all over the printing target S into a relatively flat shape. The ink K for example has a thickness of at least 0.5 μm and no greater than 5 μm. Typically, the ink K is then heated. The heating temperature is for example at least 500° C. and no greater than 850° C.

As described above with reference to FIGS. 1A-3D, in the blanket 21 of the transfer roll 20, the plurality of upper regions have top surfaces and the plurality of recesses have bottom surfaces parallel to the top surfaces. The ink K can therefore be held also in the plurality of recesses, and thus the amount of the ink K that can be transferred in a single run of printing can be increased. As a result, a thick film can be printed on the printing target S at a time.

Furthermore, the plurality of recess regions are larger than the upper regions in the recess forming region. Accordingly, the plurality of recesses can hold a greater amount of ink. As a result, a thick film can be printed on the printing target S.

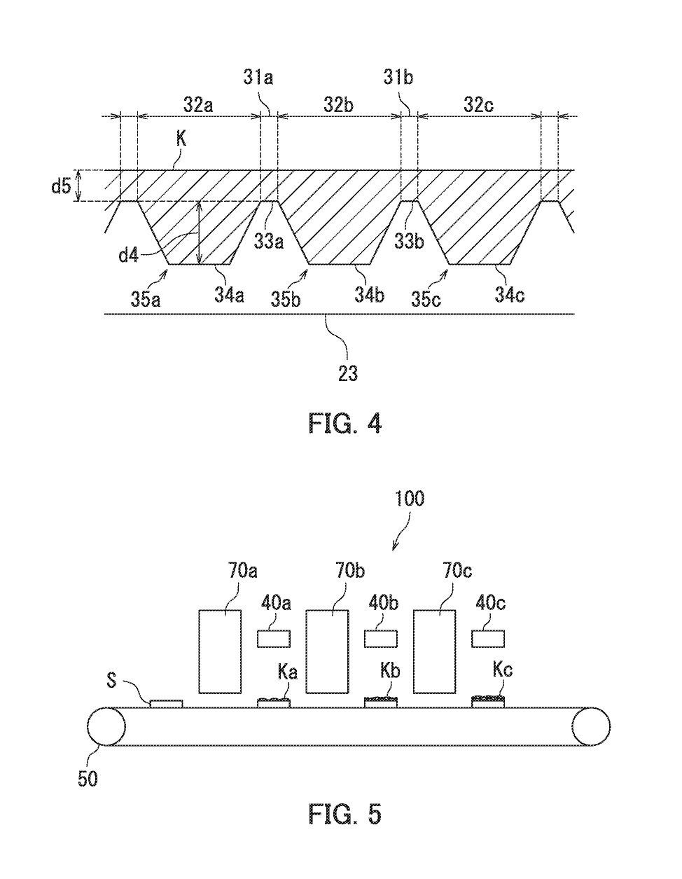

The thickness of the ink K transferred to the transfer roll 20 is described with reference to FIG. 4. FIG. 4 is a schematic enlarged view illustrating the transfer roll 20 according to the embodiment of the present invention.

The bottom surfaces (the bottom surface 34a, the bottom surface 34b, and the bottom surface 34c) of the plurality of recesses are parallel to the outer circumferential surface 23 of the core 22. A thickness d4 of the ink transferred to the recess 35a is greater than a thickness d5 of the ink K transferred to the top surface 33a. Accordingly, the plurality of recesses can hold a greater amount of ink. As a result, a thick film can be printed on the printing target S. Note that the thickness d4 of the ink transferred to the recess 35a may be smaller than the thickness d5 of the ink K transferred to the top surface 33a.

An embodiment of the printing device 100 according to the present invention is described with reference to FIG. 5. FIG. 5 is a schematic diagram of an embodiment of the printing device 100 according to the present invention.

The printing device 100 includes a printer 70a, a printer 70b, a printer 70c, a heater 40a, a heater 40b, a heater 40c, and a conveyance section 50. First, the printer 70a prints an ink Ka on the printing target S. The ink Ka is then heated by the heater 40a. Subsequently, the printer 70b prints an ink Kb on the ink Ka. The ink Kb is then heated by the heater 40b. Subsequently, the printer 70c prints an ink Kc on the ink Kb. The ink Kc is then heated by the heater 40c.

The inks are stacked in layers through overlaying of the inks as described above. Thus, thick films can be printed on the printing target S.

The printing device 100 adjusts a position of the ink to be transferred from the plurality of recesses to the printing target S by adjusting a speed at the conveyance section 50 in transferring to the printing target S.

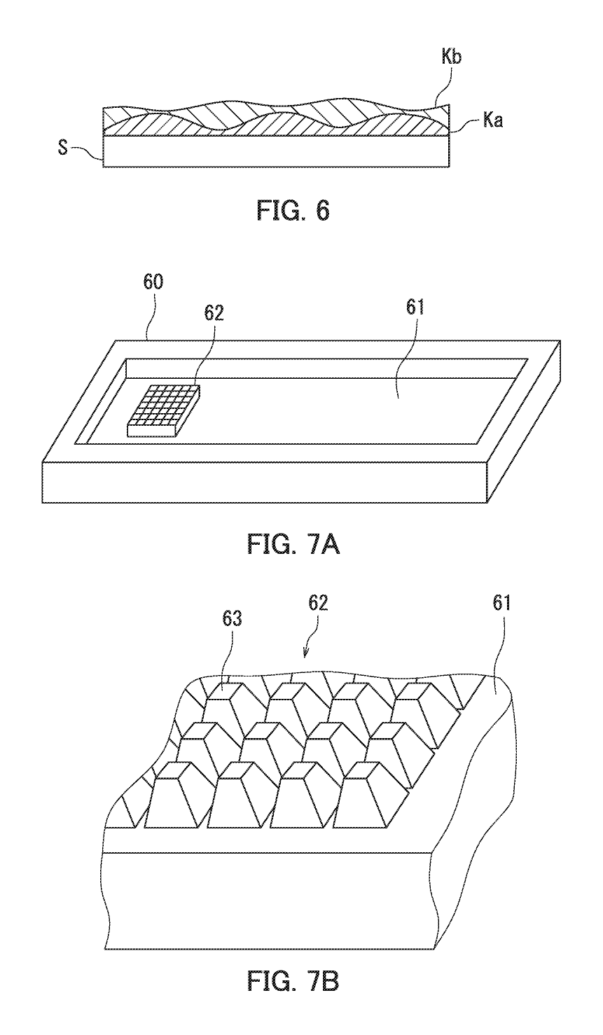

FIG. 6 is a schematic side view of inks stacked in layers on the printing target S. The ink Kb is stacked on the ink Ka. The position of the ink Kb is adjusted such that peaks of the ink Ka do not overlap peaks of the ink Kb. As a result, irregularities of the ink Ka and the ink Kb stacked in layers are reduced.

A method for manufacturing the blanket 21 according to the embodiment of the present invention is described with reference to FIGS. 7A and 7B. FIG. 7A is a schematic diagram illustrating a mold 60 that is used for manufacturing the blanket 21 according to the embodiment of the present invention. FIG. 7B is an enlarged view of the mold 60.

The mold 60 has a recess 61 corresponding to a shape of the blanket 21. A region 62 corresponding to the recess forming region 30 of the blanket 21 is provided with a plurality of protrusions 63 each having a frusto-pyramidal shape. A blanket material is poured into the mold 60 and cured to produce the blanket 21. Thereafter, the blanket 21 is wrapped around the core 22 to form the transfer roll 20.

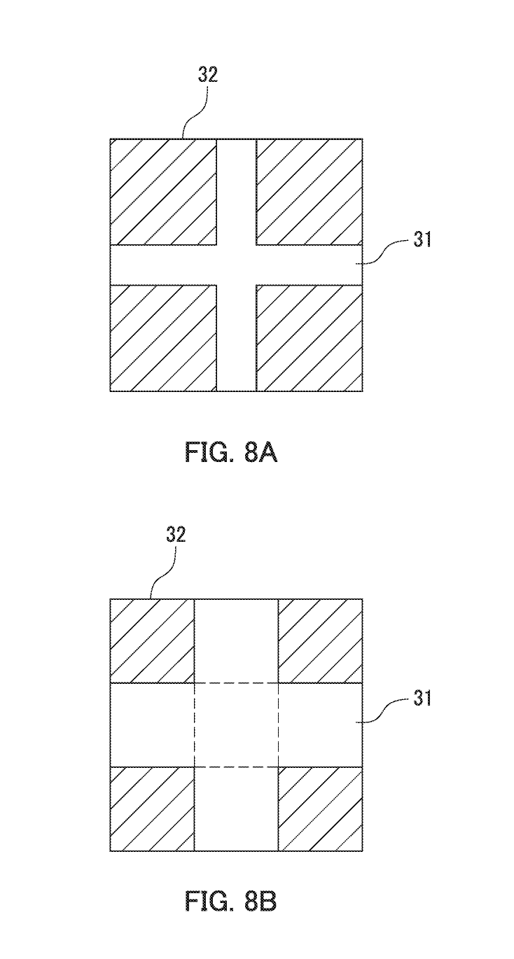

A relationship between the area of the upper regions 31 and the area of the recess regions 32 in the recess forming region 30 is described with reference to FIGS. 8A and 8B. FIGS. 8A and 8B are schematic diagrams for illustrating the relationship between the area of the upper regions 31 and the area of the recess regions 32 in the recess forming region 30.

In FIG. 8A, the area (shaded portions) of the recess regions 32 is larger than the area (white-background portion) of the upper regions 31. On the other hand, in FIG. 8B, the area (shaded portions) of the recess regions 32 is larger than the area (white-background portion) of the upper regions 31. No particular limitations are placed on the relationship between the area of the recess regions 32 and the area of the upper regions 31 in the recess forming region. However, the recess regions 32 are preferably larger than the upper regions 31 in terms of holding a greater amount of ink.

### INDUSTRIAL APPLICABILITY

The blanket according to the present invention is favorably used in a printing device that needs to print a thick film on a printing target.

### REFERENCE SIGNS LIST

K, Ka, Kb, Kc Ink
S Printing target
10 Pattern roll
20 Transfer roll
21 Blanket
22 Core
23 Outer circumferential surface
30 Recess forming region
31, 31a, 31b Upper region
32, 32a, 32b, 32c Recess region
33a, 33b Top surface
34a, 34b, 34c Bottom surface
40, 40a, 40b, 40c Heater
60 Mold
61 Recess
62 Region
63 Protrusion
70, 70a, 70b, 70c Printer
100 Printing device

1. An offset printing blanket for film formation, the blanket having a surface, wherein
the surface has a recess forming region,
the recess forming region includes a plurality of recess regions each defining a recess and a plurality of upper regions each defined by adjacent recess regions among the plurality of recess regions,
the plurality of upper regions each have a top surface,
the plurality of recesses each have a bottom surface parallel to the top surface, and
the plurality of recesses each have a depth of at least 0.3 mm and no greater than 3 mm.

2. The blanket for film formation according to claim 1, wherein
the plurality of recess regions are larger than the plurality of upper regions in the recess forming region.

3. (canceled)

4. The blanket for film formation according to claim 1, wherein
the plurality of recesses each have a size of at least 30 μm and no greater than 1,000 μm.

5. The blanket for film formation according to claim 1, wherein
the plurality of recesses are arranged in a grid.

6. A printing device comprising:
a transfer roll having the blanket for film formation according to claim 1 and a core; and
a printing plate, wherein
the blanket for film formation transfers, to a printing target, an ink transferred from the printing plate.

7. The printing device according to claim 6, wherein
a thickness of the ink transferred to the plurality of recesses is greater than a thickness of the ink transferred to the top surfaces.

8. The printing device according to claim 6, wherein
the bottom surfaces of the plurality of recesses are parallel to an outer circumferential surface of the core.

9. A printing method comprising:
providing a printing device including a printing plate and an offset printing blanket for film formation, the blanket having a surface;
transferring an ink from the printing plate to the blanket for film formation; and
transferring the ink from the blanket for film formation to a printing target, wherein
the surface has a recess forming region,
the recess forming region includes a plurality of recess regions each defining a recess and a plurality of upper regions each defined by adjacent recess regions among the plurality of recess regions,
the plurality of upper regions each have a top surface,
the plurality of recesses each have a bottom surface parallel to the top surface, and
the plurality of recesses each have a depth of at least 0.3 mm and no greater than 3 mm.

10. The printing method according to claim 9, wherein
the transferring to the blanket for film formation and the transferring to the printing target are repeated a plurality of times on the same printing target to stack the ink in layers on the printing target.

11. The printing method according to claim 10, wherein
the printing device further includes a conveyance section configured to convey the printing target, and
the transferring to the printing target includes adjusting a position of the ink to be transferred from the plurality of recesses to the printing target by adjusting a speed at the conveyance section to stack the ink in layers on the printing target such that peaks of the ink resulting from the plurality of recesses do not overlap with one another.

12. A method for manufacturing a blanket for film formation comprising:
preparing a mold having a plurality of protrusions; and
pouring a blanket material into the mold, wherein
the blanket for film formation has a surface,
the surface has a recess forming region,
the recess forming region includes a plurality of recess regions each defining a recess and a plurality of upper regions each defined by adjacent recess regions among the plurality of recess regions,
the plurality of upper regions each have a top surface,
the plurality of recesses each have a bottom surface parallel to the top surface, and
the plurality of recesses each have a depth of at least 0.3 mm and no greater than 3 mm.

13. The blanket for film formation according to claim 1, wherein
the plurality of recesses further have connection portions connecting the bottom surfaces with the top surfaces, and
in a cross-sectional view in a direction of the depth of the plurality of recesses,
a length of each of the top surfaces projected onto the same plane as the bottom surfaces is shorter than a length of each of the connection portions projected onto the same plane as the bottom surfaces, and
a length of each of the connection portions projected onto the same plane as the bottom surfaces is shorter than a length of each of the bottom surfaces.
